(19) United States
(12) Patent Application Publication
(10) Pub. No.: US 2006/0098540 A1
(43) Pub. Date: May 11, 2006

(54) Optical information recording/reproducing apparatus comprising spherical aberration mechanism

(75) Inventor: Hirotake Ando, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/261,521

(22) Filed: Oct. 31, 2005

(30) Foreign Application Priority Data
Nov. 8, 2004 (JP) 2004-323681

(51) Int. Cl. G11B 7/00

(52) U.S. Cl. 369/44.41

(57) ABSTRACT

After a spherical aberration generation amount is adjusted, gains K1 and K2 in an arithmetic operation means are adjusted.

### BACKGROUND OF THE INVENTION

1. Field of the Invention

The present invention relates to an optical information recording/reproducing apparatus for recording or reproducing an information on or from an optical recording medium such as an optical disk and the like. In particular, the invention relates to adjustment of a spherical aberration generating means and an adjusting method to be used in generation of a tracking error signal or an objective lens position signal through a differential push-pull method, which is affected by the adjustment of the spherical aberration generating means.

2. Related Background Art

In recent years, in general, in an optical disk device, the oscillation wavelength of a semiconductor laser used has become shorter, and an objective lens used has come to be high in numerical aperture (NA). For example, in the case of a BD (Blu-ray Disk) device, the wavelength is 405 nm, and the objective lens NA is 0.85. Further, for an optical disk medium used, there have been developed not only a disk having a single layer of information recording/reproducing surface but also a multilayer disk having plural layers of information recording/reproducing surfaces.

On the other hand, it is generally known that, when a thickness of a substrate (light transmissive layer) of an optical disk has an error relative to a designed value, a spherical aberration will be generated, and a spot quality on the optical recording medium is deteriorated (the spot size becomes larger, and the peak intensity relatively lowers), thereby lowering the recording/reproducing performance. Further, it is also known that the amount of spherical aberration generated is proportional to approximately 4 powers of the objective lens NA, and is inversely proportional to the wavelength.

Consequently, the BD device is extremely prone to cause a spherical aberration as compared to the DVD device and the like. Hence, in a case where an optical disk is exchanged or in a case where a recording/reproducing position is considerably changed during use of a same optical disk or in a case where change is performed from an information surface of a multilayer optical disk having a plurality of information surfaces to another information surface, or the like, it is necessary to correct a spherical aberration caused thereby.

As a device for correcting such spherical aberration, for example, there is one disclosed in Japanese Patent Application Laid Open No. 2002-322971. The device disclosed therein has a spherical aberration correcting means in which two lenses are disposed between a collimator lens and an objective lens, and one lens is moved in an optical axis direction by a DC motor so that the lens interval is made variable, thereby generating a spherical aberration. The correction is performed by a process in which, when a disk is inserted or a recording/reproducing operation continues for a predetermined period of time, a position where a reference signal becomes maximum while changing the lens interval, and the lens interval is fixed at the position where the reference signal becomes maximum.

Further, as a tracking error detection method of the optical disk, there are various methods available, and as one of the methods, the differential push-pull method (hereinafter referred to as DPP method) is known. The DPP method involves irradiating a disk with a plurality of beams at predetermined intervals, and arithmetically operating detection signals obtained from reflected lights, thereby generating a tracking error signal which is suppressed in an offset due to movement of an objective lens.

Further, by changing the arithmetic operation method of the detection signal, a position detection signal of the objective lens is generated. Such a technique is, for example, disclosed in Japanese Patent Application Laid-Open Nos. H07-93764 and 2000-331356.

The DPP method will be further described below. First, a light flux emitted from a light source is split into a main beam being 0-order beam and two subbeams being ±1-order lights by a wavefront splitting element disposed between the light source and an objective lens. The beams are condensed on an optical disk by the optical lens, and the reflected lights from the optical disk of the main beam and two subbeams are received by photodetectors such as illustrated in FIG. 8. A main beam photodetector 100 for receiving the main beam of 0-order light is vertically and horizontally divided into four sections. Subbeam photodetectors 101 and 102 for receiving subbeams of ±1-order lights are vertically divided into two sections. When outputs from the sections of the element are represented by A, B, C, D, E, F, G, and H, a tracking error signal and a lens position detection signal are generated by arithmetically operating the signals.

That is, a push-pull signal MPP of the main beam is obtained by:
MPP=(A+D)−(B+C), and
a sum SPP of push-pull signals of the subbeams is obtained as an output obtained by adding the push-pull signal outputs of the subbeams together as represented by:
SPP=(E−F)+(G−H).

Further, a tracking error signal DPP is obtained by subtracting a signal which is K0 times the SPP from the MPP, as represented by:
DPP=MPP−K0×SPP.

Here, the K0 is a constant determined so as to correct/calibrate a difference in light intensity between the main beam and two subbeams, and for example, is set such that a DC offset accompanied with the movement of the objective lens is not generated.

On the other hand, a lens position detection signal LPS is obtained by:
LPS=MPP+K0×SPP.

At this time, the disposition of spots on the optical disk is as shown in FIG. 9 by rotational adjustment about an optical axis of a diffraction grating. A main spot 200 by the main beam is disposed on a groove and subspots 201 and 202 by the subbeams are disposed on lands at symmetrical positions with the main spot therebetween. In FIG. 9, the groove portion of the disk is hatched. That is, when a groove cycle is taken as a reference, the intervals between the spot and the subspots are approximately half the groove cycle.

As a result, by setting the K0 to an appropriate value, the DPP signal takes an amplitude approximately equal to an expected maximum value, and moreover, occurrence of an offset due to the objective lens position movement is suppressed. At the same time, from the LPS signal, only an offset component generated by each push-pull signal due to the objective lens position movement is extracted, so that a signal corresponding to the objective lens position movement is obtained.

This LPS signal is used to control vibration of the objective lens generated when an optical head is allowed to seek in a radial direction of the disk or to prevent displacement of the objective lens due to its dead weight by the attitude of the optical head.

Further, the adjustment of the K0 is performed such that an alternating current component (tracking modulation component) contained in the LPS signal becomes minimum or a DC offset component contained in the DPP signal becomes minimum when shifting the objective lens by a predetermined amount.

As disclosed in Japanese Patent Application Laid-Open No. 2002-322971, it is known that intervals between a main beam and subbeams vary by adjustment operation of a spherical aberration generating means. In the Japanese Patent Application Laid-Open No. 2002-322971, there is disclosed an optical system for controlling such errors to be within tolerances. Further, while the quality of a main beam and subbeams is deteriorated by a position of a spherical aberration generating means, there is a case where the degrees of the deterioration becomes different from each other. In such a case, the ratios of the DC offsets due to the objective lens movement of the MPP signal and the SPP signal to the push-pull amplitude may be changed.

That is, the offset due to the objective lens position shift of the DPP signal and the mixing ratio of the tracking error component of the LPS signal come to change depending on the position of the spherical aberration generating means. In the case of a multilayer disk, since the position of the spherical aberration generating means will largely change, the influence thereof is considered to be more significant.

The occurrence of an offset due to the objective lens position of the DPP signal becomes an error of the tracking control, and causes writing on an adjacent track at the time of recording, an increase of cross talk from an adjacent track to a reproducing signal, and the like, thereby becoming a cause of deterioration of the recording/reproducing signal. Further, the mixing of a tracking error component into the LPS signal becomes a disturbance to the lens position fixing control at the time of seeking or the like, and destabilizes the seeking, thereby causing an increase in the access time and a seeking failure, and the like.

### SUMMARY OF THE INVENTION

It is an object of the present invention to provide an optical information recording/reproducing apparatus capable of suppressing an increase of error of a DPP signal or LPS signal due to adjustment of a spherical aberration generating means and automatically adjusting every optical recording medium or every recording/reproducing information surface of an optical recording medium.

To achieve the above described object, the present invention provides an optical information recording/reproducing apparatus, comprising:

a light source;

a wavefront splitting element for splitting a light flux from the light source into three light fluxes of 0-order light and ±1-order lights;

an objective lens for condensing the light fluxes as split by the wavefront splitting element on an optical recording medium;

a spherical aberration generating means disposed between the light source and the objective lens, for generating a spherical aberration in the light fluxes;

a first adjusting means for adjusting a generation amount of the spherical aberration of the spherical aberration generating means;

a photodetector for detecting reflected lights from the optical recording medium of the three light fluxes;

an arithmetic operation means for arithmetically operating an tracking error signal or an objective lens position signal showing a position in a tracking direction of the objective lens, based on an output signal of the photodetector; and

a second adjusting means for adjusting a gain in the arithmetic operation means after adjusting the generation amount of the spherical aberration by the first adjusting means.

According to the present invention, by adjusting a tracking error signal or a lens position signal after adjustment of a spherical aberration generation amount, it is possible to always obtain an optimum tracking error signal or lens position signal independently of the state of a spherical aberration generating means.

### BRIEF DESCRIPTION OF THE DRAWINGS

FIG. 1 is a block diagram showing a first embodiment of an optical information recording/reproducing apparatus in accordance with the present invention;

FIG. 2 is a block diagram showing an optical head of FIG. 1;

FIG. 3 is a flowchart showing the operation of the first embodiment;

FIG. 4 is a circuit diagram showing another constitutional example of an arithmetic operation means;

FIG. 5.is a block diagram showing a second embodiment in accordance with the present invention;

FIG. 6 is a flowchart showing the operation of the second embodiment;

FIG. 7 is a graphical representation showing the relation between a spherical aberration correction amount and a signal amplitude;

FIG. 8 is a view showing a constitution of a photodetector;

FIG. 9 is a view showing a spot disposition on an optical disk; and

FIG. 10 is a flowchart showing the operation of a third embodiment in accordance with the present invention.

### DESCRIPTION OF THE PREFERRED EMBODIMENTS

Next, the best mode for carrying out the invention will be described in detail with reference to the drawings.

### First Embodiment

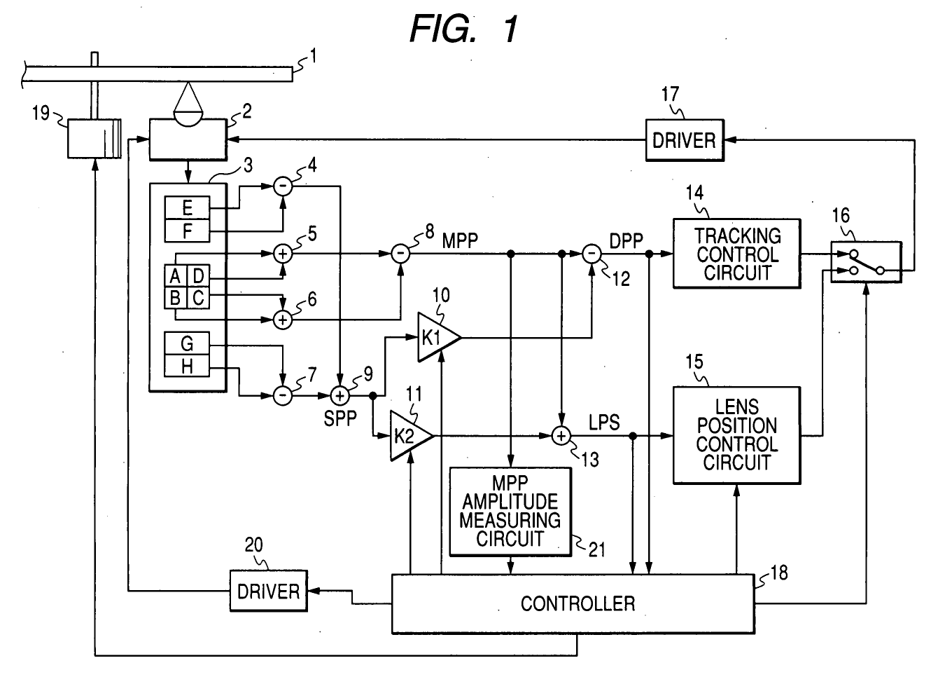

FIG. 1 is a block diagram showing an optical disk apparatus in accordance with a first embodiment of the present invention. In the Figure, reference numeral 1 denotes an optical disk, reference numeral 2 an optical head for recording/reproducing an information on or from the optical disk, and reference numeral 3 a photodetector within the optical head. Further, A to H denote detecting elements of a split pattern of the photodetector 3. Reference numerals 4 to 13 denote an arithmetic circuit to perform addition, subtraction, multiplication or the like for generating a DPP signal and an LPS signal, reference numeral 14 a tracking control circuit taking a DPP signal as an input, reference numeral 15 lens position control circuit taking an LPS signal as an input, reference numeral 16 a switch, reference numeral 17 a driver circuit for driving a tracking actuator, reference numeral 18 a controller, reference numeral 19 a spindle motor, reference numeral 20 a driver circuit for actuating a spherical aberration generating means, and reference numeral 21 an MPP signal amplitude measuring circuit.

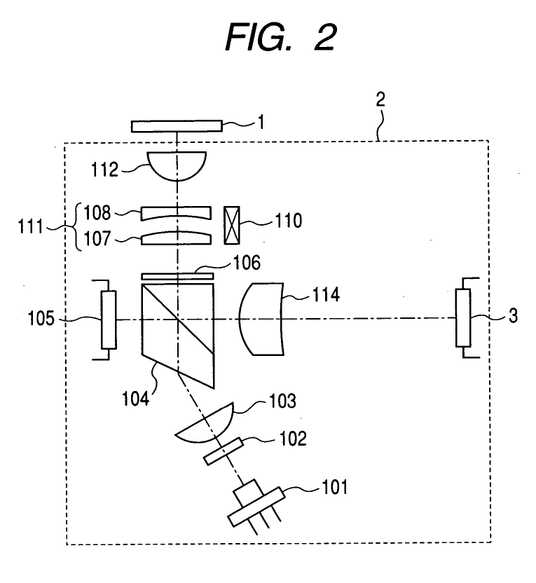

FIG. 2 is a view showing the optical head 2. A beam emitted from a semiconductor laser 101 is split into three beams by a diffraction grating 102, and is made a parallel beam by a collimator lens 103, and enters a polarization beam splitter 104 with a beam shaper. A part of the beams is reflected, and enters an APC sensor 105, and is used for monitoring the amount of light exiting from the semiconductor laser 101. The transmitted beam is condensed onto a recording layer surface through a light transmissive layer on the optical disk 1 by the optical lens 112 through a quarter wavelength plate 106, a lens 107, and a lens 108, and is used for reproducing/recording the information. A beam reflected by the optical disk 1 is reflected by the polarization beam splitter 104 with a beam shaper, and enters the photodetector 3 through a sensor lens 114, and is used for reproducing an information signal.

Here, of the lens 107 and the lens 108, the lens 107 is fixed, and the lens 108 is set so as to be movable in the optical axis direction, and is held by an electromagnetic drive means 110 such that the distance from the lens 107 in the optical axis direction is variable, thereby forming a spherical aberration generating means 111. The shapes and materials of the lenses 107, 108 are selected and designed such that only a spherical aberration is generated when the lens interval is changed. As the electromagnetic drive means 110, a stepping motor is typically used, and the lens 108 is moved in a micron order by a lead screw.

At this time, a design is made such that an optimum focus position on the optical disk 1 is changed by about 1 μm for every 20 μm movement of the lens 108. This ratio is based on design of an optical system, and can be appropriately determined according to the intended use.

Further, three beams as split by the diffraction grating 102 are reflected by the optical disk 1, returns to the optical head 2 and is received by the photodetector 3. The 0-order diffracted light is received by the elements A, B, C, and D of the eight elements as split of the photodetector 3, and the two 1-order diffracted lights are received by the elements E, F and H, G. The outputs A and D of the photodetector 3 are added together by an addition circuit 5, and the outputs B and C by an addition circuit 6, respectively, and after that, are subjected to subtraction by a subtraction circuit 8, and become a push-pull signal MPP of the main beam. Further, the outputs E and F are subjected to subtraction by a subtraction circuit 4, and the outputs G and H by a subtraction circuit 7, respectively, and become push-pull signals of the two subbeams, and moreover, these push-pull signals are added together by an addition circuit 9, thereby becoming a sum SPP of the push-pull signals of the subbeams.

The SPP signal is multiplied by a gain K1 in a multiplication circuit 10, and is then subtracted from the MPP signal in a subtraction circuit 12, and becomes a tracking error signal DPP. Further, the SPP signal is multiplied by a gain K2 in a multiplication circuit 11, and is then added with the MPP signal in a addition circuit 13 so as to become an objective lens position signal LPS showing a position in the tracking direction of the objective lens 112.

The DPP signal is inputted to a switch 16 through a tracking control circuit 14, and the LPS signal is inputted to another terminal of the switch 16 through a lens position control circuit 15. The switch 16 is controlled by a controller 18, and is connected to the tracking control circuit 14 at the time of tracking control, and to the lens position control circuit 15 at the time of lens position control. Further, the switch 16 is connected to a tracking actuator within the optical head 2 through a driver 17, and constitutes respective control loops. Further, the controller 18 controls the spherical aberration generating means 111 in the optical head 2 shown in FIG. 2 through a driver circuit 20, thereby adjusting the spherical aberration so to be in an optimum state.

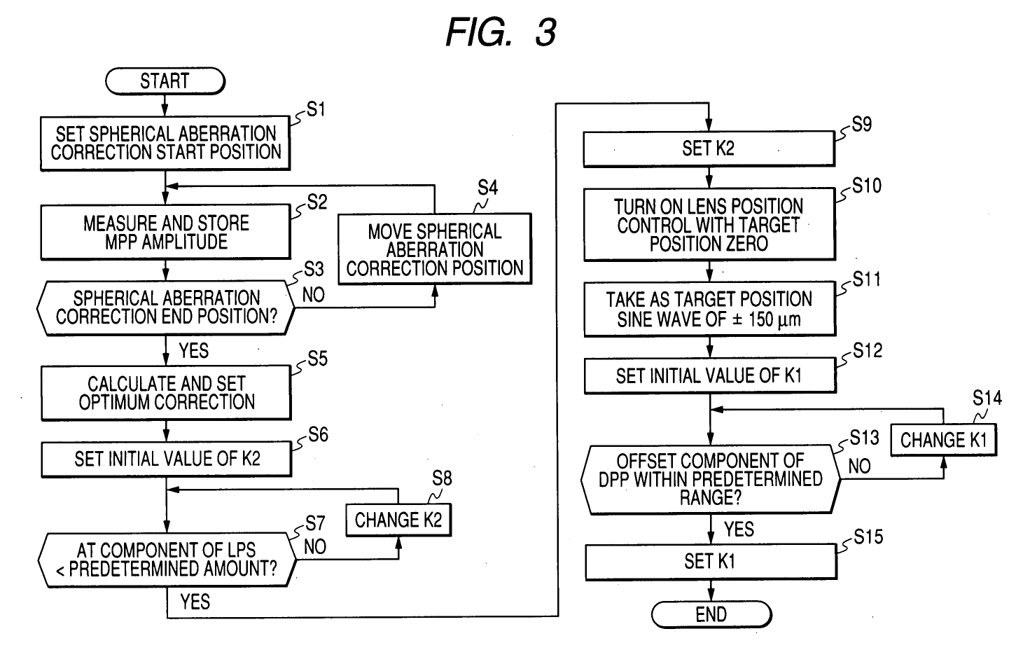

Next, the adjusting method of the spherical aberration, the DPP, and the LPS will be described along the flowchart of FIG. 3. When the optical disk device of the present embodiment is activated, the controller 18 performs activation of the spindle motor 19, turning on of a laser, focus pull-in, and the like. Such adjustment is performed under focus control of the optical disk 1. Although the focus control is not described in detail, a focus error signal is detected by a conventional astigmatic focus error detection technique from the four outputs A, B, C, and D of the photodetector 3, thereby performing the focus control.

The adjustment starts from the spherical aberration correction. When a spherical aberration correction routine starts, first, the spherical aberration generating means 111 (the movable lens 108) is set to a predetermined start position (S1). For example, in a case where a medium substrate of an ordinary thickness is used, the start position is a position deviated by a predetermined amount from the reference position with designed values giving such an aberration as to eliminate the spherical aberration on the medium surface.

The generation amount of the spherical aberration at this time is assumed to be −4. It is further assumed, for example, that one unit of this generation amount moves the lens 108 by 10 μm. At this time, since the focus position is changed by 1 μm for every 20 μm movement of the lens 108 as described above, the 10 μm movement corresponds to 0.5 μm change of the focus position. The amount “−4” refers to a state in which the lens 108 is moved by 40 μm from the reference position in a direction approaching to the lens 107. This state corresponds in design to a position where the spherical aberration becomes the optimum state when the medium substrate thickness increases by 2 μm in a thicker direction.

Next, the controller 18 inputs the output signal amplitude of the MPP signal, which is the push-pull signal of the main beam, from an MPP signal amplitude measuring circuit 21, and stores it in a memory or the like as an evaluation index in association with the correction amount −4 (S2).

Next, the controller 18 confirms whether or not the spherical aberration generating means 111 (the movable 108) is at an end position (S3). The end position corresponds to a position of +4 in terms of the spherical aberration generation amount, and is in a state in which the lens 108 is moved by 40 μm from the reference position in the direction departing from the lens 107. This state corresponds in design to a position where the spherical aberration becomes the optimum state when the medium substrate thickness decreases by 2 μm in a thinner direction.

In a case where the spherical aberration generating means 111 is not at the end position, the spherical aberration correction amount is increased stepwise each by one until it comes to the end position (S4), and the MPP signal amplitude is measured by the MPP signal amplitude measuring circuit 21, and is stored in association with the correction amount (S2). Since the correction amount is increased one by one unit, this means that the lens 108 is moved stepwise each by 10 μm, and the MPP signal amplitude at that position is evaluated.

The MPP signal amplitude measuring circuit 21 may be such that the amplitude of the MPP signal is determined by, for example, a peak hold circuit and a bottom hold circuit. Alternatively, the circuit 21 may be one utilizing a method in which the MPP amplitude is taken in by an AD converter and a MAX value and a MIN value are stored.

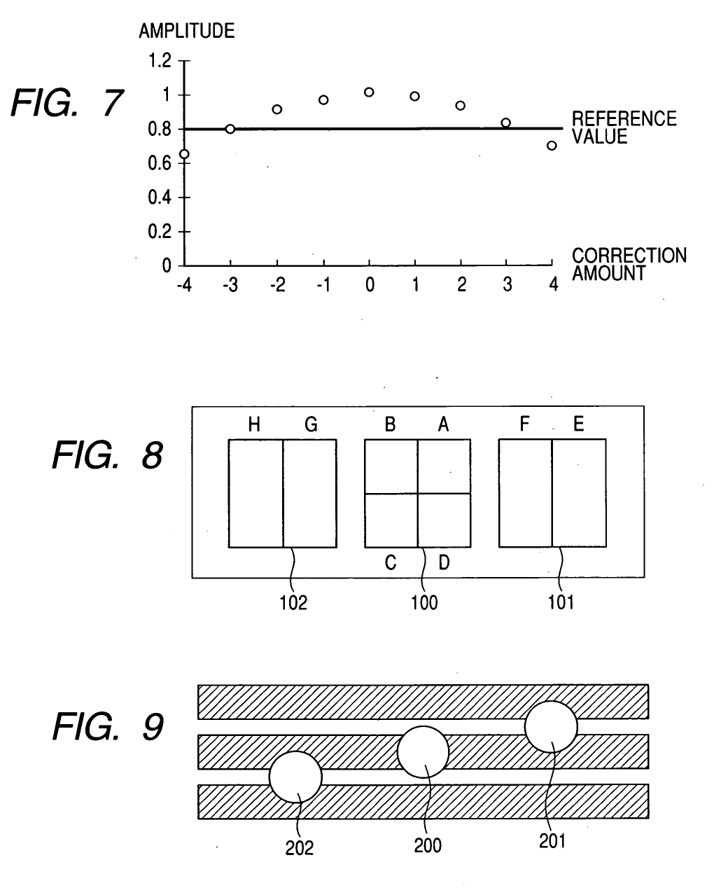

When the relation between the spherical aberration correction amount and the signal amplitude is graphically represented with the correction amount as abscissa and the MPP amplitude value as ordinate, it is represented by o in FIG. 7. To find an optimum spherical aberration correction amount, an MPP amplitude value associated with the stored correction amount is used. Correction amounts at two points, where the MPP amplitude value exceeds the reference value, are determined, and a median value of the correction amounts of the two points is taken as an optimum spherical aberration correction amount. In order to accurately determine an optimum spherical aberration correction amount from discrete correction amounts, a correction amount exceeding the reference value is determined from each correction amount by linear interpolation and the like.

In the example represented by o in FIG. 7, since the correction amount crossing the reference value at the negative side is −3.0, and since the correction amount crossing the reference value at the positive side is 3.3, the optimum spherical aberration correction amount is determined to be 0.15. The thus determined correction amount is set to the spherical aberration generating means 111 (S5). In this manner, the correction of the spherical aberration is completed.

Subsequently, the adjustments of K1 and K2 of the DPP and LPS signals are performed. First, the adjustment of K2 is performed. In a first step, K2 is set to an initial value of a smallest value which is conceivable design-wise (S6). In that state, the controller 18 observes a tracking error modulation component of the LPS, and judges (S7) whether or not it is less than a predetermined amount (approximately 0). An example of the observing method of the modulation component is one in which a peak hold value and a bottom hold value of the LPS are observed, and it is judged whether or not a difference thereof is less than the predetermined amount. Alternatively, a method may be used in which a maximum value and a minimum value are detected and a difference thereof is used for the judgment.

In a case where it is not less than the predetermined amount, the value of K2 is increased by a predetermined amount, and the tracking error component of the LPS is detected, followed by the judgment, which is repeated until a difference less than the predetermined amount is attained (S8). The value of K2 at which a difference less than the predetermined amount is attained is taken as an optimum value (S9). At this point of time, the zero point of the LPS signal becomes approximately a center position at the time of factory adjustment.

Next, the controller 18 takes zero as the target value of the lens position control, and connects the switch 16 to the lens position control circuit 15, and turns on the lens position control loop. Thereby, the objective lens is fixed to a point which attains LPSO (S10). At this time, the control frequency band of the lens position control is set to approximately 500 Hz so as to sufficiently endure disturbances such as gravity, vibration, and the like.

Subsequently, the controller 18 changes the target value of the lens position control to a sine wave of a predetermined frequency at a predetermined amplitude with zero as a center. The predetermined frequency is, for example, 10 Hz, and the amplitude is taken as a value at which the objective lens moves by approximately ±150 μm (S11). The controller 18 sets a designed optimum value as the initial value for the value of K1 (S12).

The initial value of K1 at this time may be the optimum value of K2. In a case where the optical system and the like are properly adjusted, K1 and K2 are equal to each other. The difference between K1 and K2 is an adjustment error, and if the adjustment error is within a predetermined range, giving an optimum value of K2 as an initial value of K1 can shorten the convergence time of the subsequent adjustment of K1.

The controller 18 detects an offset amount which is a median value between a maximum value and a minimum value of the DPP signal, and increases or decreased the magnitude of K1 based on the sign of the lens position target value and the sign of the offset as described below. The detection of the offset amount may be performed such that the DPP signal is peak-held and bottom-held, and a median value thereof is taken as-the offset amount.

For example, it is presumed that the signs of the DC offsets of the main beam (MPP) and the subbeams (SPP) become negative when the objective lens moves to the inner periphery side, and changes to positives when the objective lens moves to the outer periphery side. Further, it is also presumed that when the target value of the lens position control is made a negative, the objective lens moves to the inner periphery side, and when the target value is made a positive, the objective lens moves to the outer periphery side. The DPP signal is represented by MPP-K1×SPP. Therefore, in a case where the offset of the DPP is a positive when the target value of the lens position control is a positive, it means that the correction is not sufficient, so that K1 may be made larger.

In contrast to this, in a case where the offset of the DPP is a negative when the lens position control target value is a positive, it means that the correction is excessive, so that K1 may be made smaller. In a case where the lens position target value is a negative, the situation is reversed. That is, when the offset of the DPP is a negative, it means that the correction is not sufficient, and therefore, k1 may be made larger, while in a case where the offset of the DPP is a positive, it means that the correction is excessive, and therefore, K1 may be made smaller.

During one cycle of the sine wave, until the variation of the offset of the DPP comes to fall within a predetermined range (a range in the vicinity of zero), the above operation is repeated (S13 and S14). When coming to fall within the predetermined range, the value of K1 at that time is taken as an optimum value (S15). By making adjustment in this manner, it is possible to adjust the gains K1 and K2 to the optimum values of the LPS and the DPP, respectively.

In the present embodiment, since all the adjustments are completed with the tracking control being in off state, there is no need to turn on tracking control by the DPP signal which has not been adjusted. Further, the adjustment of the spherical aberration is performed first and then the adjustments of the DPP and the LPS are performed, so that, after the adjustments are completed, the spherical aberration as well as the DPP and LPS signals have all become the optimum values, and the recording/reproducing operations can be started immediately.

Incidentally, though in the above description, the optical system as shown in FIG. 2 is used as the spherical aberration correcting means, any system may be adopted as long as it is a system in which a DPP signal is affected by occurrence of spherical aberration such as a liquid crystal element. Further, although the objective lens needs to be moved by a predetermined amount at the time of K1 adjustment, it can be moved by the predetermined amount under the lens position control by the LPS signal as previously adjusted, so that the adjustment can be performed within a stable operation range without being affected by a disturbance such as gravity, vibration and the like.

Further, though a sine wave is taken as the target value of the lens position control at the time of K1 adjustment, any wave form may be adopted as long as it can move the objective lens position by a predetermined amount, such as a ramp wave, a delta wave, a square wave, or the like. Further, in the present embodiment, it is possible, even during the period from the spherical aberration correction operation until the completion of the K2 adjustment, to turn on the lens position control with the target value as zero. In this case, so as not to respond to a high frequency component of a tracking error modulation component, it is preferable to set the control frequency band of the lens position control to approximately 100 Hz to the extent that the movement of the objective lens by gravity is suppressed.

In this manner, in any one of the adjustments of the spherical aberration, the DPP, and the LPS, the lens position control can be turned on, and the adjustment can be performed within a stable operation range without being affected by disturbances such as gravity, vibration and the like.

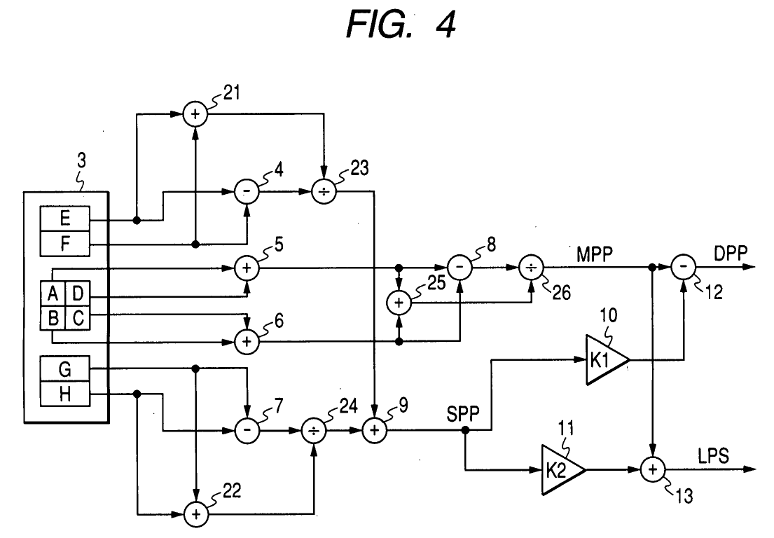

Further, for the arithmetic circuits of the MPP signal, the DPP signal, and the LPS signal shown in FIG. 1, in a case where, similarly to the recordable/reproducible disk, there are a change of a laser power due to a recording power, a change of reflectance in recorded and non-recorded states within the disk, a constitution of an arithmetic circuit shown in FIG. 4 is needed.

FIG. 4 will be briefly described. What is different from the arithmetic circuit of FIG. 1 is that addition circuits and division circuits 21 to 26 are added. The MPP signal is a signal obtained by dividing (A+D)−(B+C) by the output {(A+D)+(B+C)} of the addition circuit 25 by means of the division circuit 26. Further, the SPP signal is a signal obtained by addition in the addition circuit 9 of a signal obtained by dividing the signal (E−F) by the output (E+F) of the addition circuit 21 by means of the division circuit 23 and a signal obtained by dividing the signal (G−H) by the outputs (G+H) of the addition circuit 22 by means of the division circuit 24. By dividing the push-pull signals of the three beams by the total sum signals of the beams respectively, the signals are each normalized.

By constituting in this manner, the amplitude of the MPP signal can be obtained independently of the change in the laser power and the change in the reflectance within the disk, and accurate correction of the spherical aberration can be performed for every disk, and at the same time, the optimum DPP signal and LPS signal can be obtained by adjustment of K1 and K2.

### Second Embodiment

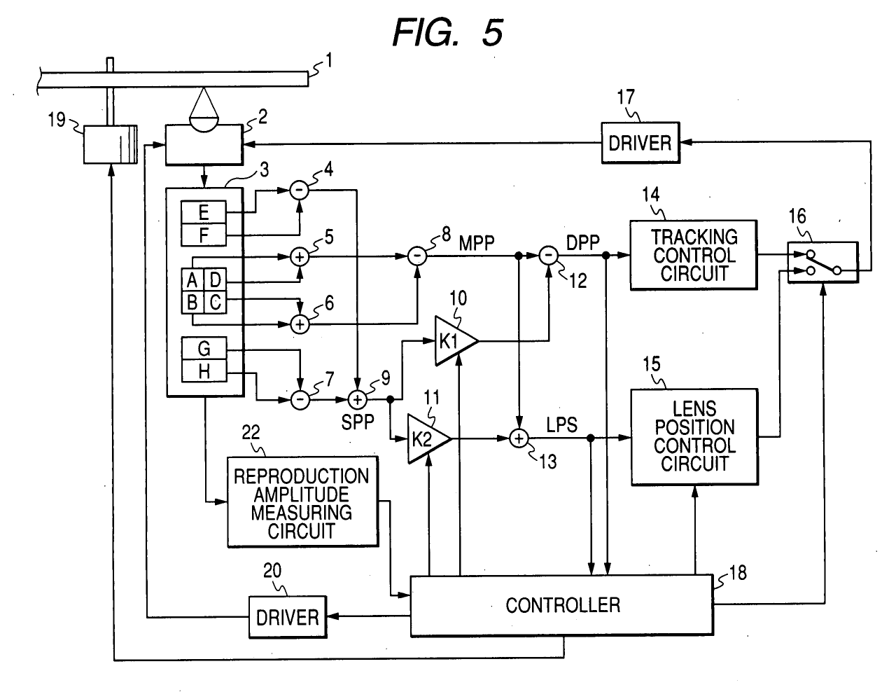

FIG. 5 is a block diagram showing a second embodiment of the present invention. In FIG. 5, what is different from FIG. 1 is that, instead of the MPP signal amplitude measuring circuit 21, there is used a reproduction signal amplitude measuring circuit 22. The reproduction signal amplitude measuring circuit 22 takes as an input signal the 0-order diffracted light received by the photodetector 3, that is, the sum of the outputs of the four elements A, B, C, and D of the eight split elements of the photodetector 3, and determines an amplitude from a peak hold value and a bottom hold value of the inputted signal.

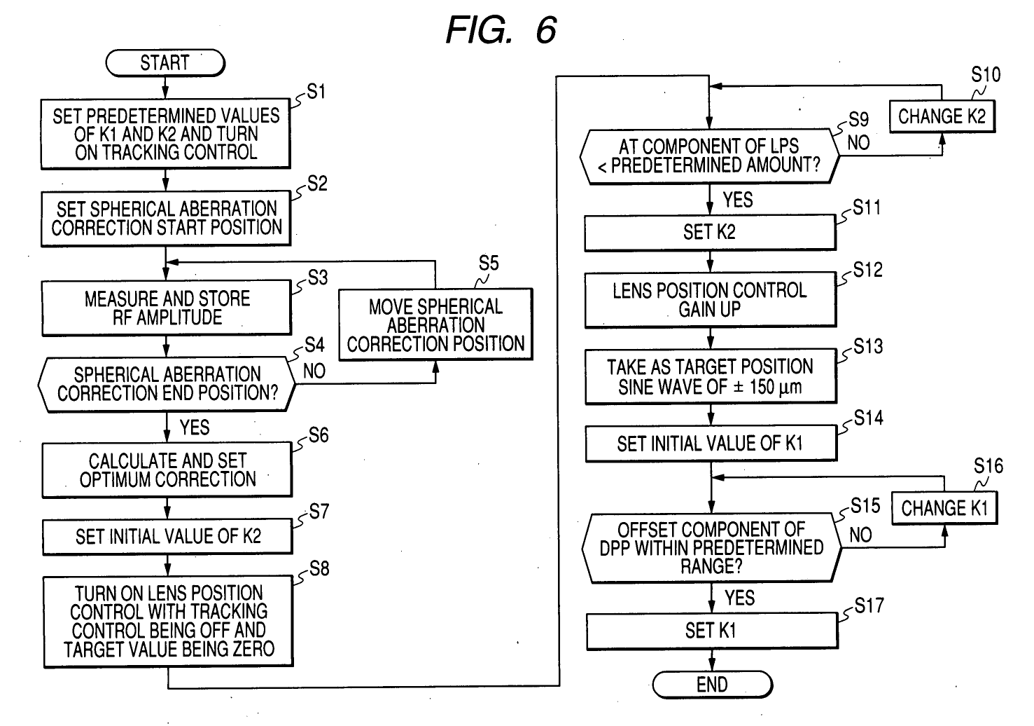

Next, the operation of the present embodiment will be described according to the flowchart of FIG. 6. First, when the optical disk apparatus of the present embodiment is activated, a controller 18 performs activation of a spindle motor 19, turning on of a laser, focus pull-in, and the like. The focus pull-in is performed in an area in which a predetermined pattern is recorded. Although the focus control is not described in detail, a focus error signal is detected by a conventional astigmatic focus error detection technique from the four outputs A, B, C, and D of the photodetector 3, thereby performing the focus control.

When a spherical aberration correction routine starts, first, a controller 18 sets the designed optimum value to K1 and K2, and a switch 16 is connected to a tracking control circuit 14, and a tracking control is turned on (S1). Since a DPP signal used for tracking control is not adjusted, there is a possibility of causing an offset by movement of an objective lens, but because no recording/reproducing are performed in this state, there is no practical problem.

First, the adjustment starts from the spherical aberration correction. Spherical aberration generating means 111 (the fixed lens 108) is set at a predetermined start position (S2). This is, similarly to the first embodiment, in a case where a medium substrate of an ordinary thickness is used, the start position is a position deviated by a predetermined amount from the reference position with designed values giving such an aberration as to eliminate the spherical aberration on the medium surface. The generation amount of the spherical aberration at this time is assumed to be −4. It is further assumed, for example, that one unit of this generation amount moves the lens 108 by 10 μm. The amount “−4” refers to a state in which the lens 108 is moved by 40 μm from the reference position in a direction approaching to the lens 107. This state corresponds in design to a position where the spherical aberration becomes the optimum state when the medium substrate thickness increases by 2 μm in a thicker direction.

Next, the controller 18 stores the reproduction signal amplitude value, which is the output of the reproduction signal amplitude measuring circuit 22, in a memory or the like as an evaluation index in association with the correction amount −4 (S3). Further, the controller 18 confirms whether or not the spherical aberration generating means 111 (the movable 108) is at an end position (S4). The end position corresponds to a position of +4 in terms of the spherical aberration generation amount, and is in a state in which the lens 108 is moved by 40 μm from the reference position in the direction departing from the lens 107. This state corresponds in design to a position where the spherical aberration becomes the optimum state when the medium substrate thickness decreases by 2 μm in a thinner direction.

In a case where the spherical aberration generating means 111 is not at the end position, the spherical aberration correction amount is increased stepwise each by one until it comes to the end position (S5), and the reproduction signal amplitude is measured by the reproduction signal amplitude measuring circuit 22, and is stored in association with the correction amount (S3). Since the correction amount is increased one by one unit, this means that the lens 108 is moved stepwise each by 10 μm, and the reproduction signal amplitude at that position is evaluated.

When the relation between the spherical aberration correction amount and the reproduction signal amplitude value is graphically represented with the correction amount as abscissa and the reproduction signal amplitude value as ordinate, it is represented by o in FIG. 7. To find an optimum spherical aberration correction amount, a reproduction amplitude value associated with the stored correction amount is used. Correction amounts at two points, where the reproduction amplitude value exceeds the reference value, are determined, and a median value of the correction amounts of the two points is taken as an optimum spherical aberration correction amount. In order to accurately determine an optimum spherical aberration correction amount from discrete correction amounts, a correction amount exceeding the reference value is determined from each correction amount by linear interpolation and the like.

In the example represented by o in FIG. 7, since the correction amount crossing the reference value at the negative side is −3.0, and since the correction amount crossing the reference value at the positive side is 3.3, the optimum spherical aberration correction amount is determined to be 0.15. The thus determined correction amount is set to the spherical aberration generating means 111 (S6).

In the present embodiment, with respect to the reproduction signal for the spherical aberration correction, though the reproducing operation is performed in a state in which the tracking control is not optimum, even when the tracking control is not performed at an optimum position of the reproduction signal, the fact does not change that the reproduction signal becomes maximum at an optimum position of the spherical aberration correction. That is, at the time of the spherical aberration adjustment, since it is sufficient that only the amplitude of the reproduction signal can be observed, the tracking is not required to be optimum. In this manner, the correction of the spherical aberration is completed.

Subsequently, the adjustments of K1 and K2 of the DPP and LPS signals are performed. First, the adjustment of K2 is performed. In a first step, K2 is set to an initial value of a smallest value which is conceivable in design (S7). Next, the controller 18, with the target value of the lens position control as zero, connects the switch 16 to the lens position control circuit 15, turns off the tracking control, and at the same time turns on the lens position control loop (S8). The control frequency band of the lens position control at this time is set to approximately 100 Hz such that the movement of the objective lens due to gravity can be suppressed.

In this case, since the frequency band of the lens position control is made lower, the controller 18 does not respond to a high frequency component of a tracking error modulation component. In this state, the controller 18 observes the tracking error modulation component of the LPS, and judges whether or not it is less than the predetermined amount (approximately zero) (S9).

When it is not less than the predetermined amount, the controller 18 increases the value of K2 by a predetermined amount, and detects the tracking error component of the LPS again, which is repeated until the value becomes less than the predetermined amount (S10), and the value of K2 when it becomes less than the predetermined amount is taken as an optimum value (S11).

Next, the controller 18 controls the lens position control circuit 15, and raises the control frequency band of the lens position control. At this time, it is set to approximately 500 Hz (S12). At this point of time, the zero point of the LPS signal becomes approximately a center position at the time of factory adjustment, and the relation between the objective lens position and the output of the LPS becomes approximately the value at the time of factory adjustment.

Subsequently, the controller 18 changes the target value of the lens position control to a sine wave of a predetermined frequency at a predetermined amplitude with zero as a center. The predetermined frequency is, for example, 10 Hz, and the amplitude is taken as a value at which the objective lens moves by approximately ±150 μm (S13).

The controller 18 sets a designed optimum value as the initial value for the value of K1 (S14). The initial value of K1 at this time may be the optimum value of K2. In a case where the optical system and the like are properly adjusted, K1 and K2 are equal to each other. The difference between K1 and K2 is an adjustment error, and if the adjustment error is within a predetermined range, giving an optimum value of K2 as an initial value of K1 can shorten the convergence time of the subsequent adjustment of K1.

The controller 18 detects an offset amount which is a median value between a maximum value and a minimum value of the DPP signal, and increases or decreased the magnitude of K1 based on the sign of the lens position target value and the sign of the offset. The procedure therefor is as described in the first embodiment.

During one cycle of the sine wave, until the variation of the offset of the DPP comes to fall within a predetermined range (a range in the vicinity of zero), the above operation is repeated (S15 and S16). When coming to fall within the predetermined range, the value of K1 at that time is taken as an optimum value (S17). By making adjustment in this manner, it is possible to adjust the gains K1 and K2 to the optimum values of the LPS and the DPP, respectively.

In the present embodiment, the tracking control is turned on before the adjustment of the DPP and the LPS, and performs the adjustment of the spherical aberration correction. Hence, even in a case where the spherical aberration correction position at which the MPP signal amplitude becomes maximum and the spherical aberration correction position at which the reproduction signal amplitude becomes maximum are different from each other depending on the light beam shape on the disk or the like, it is possible to perform adjustment to the spherical aberration correction position at which the reproduction signal becomes optimum.

Further, because at the time of K2 adjustment, the adjustment is under the lens position control, even in a case where the objective lens position becomes to be outside of an operation compensation range due to gravity and the like, the objective lens can be located approximately at a center, and it is possible to make an accurate adjustment. Further, under the lens position control by the LPS signal adjusted earlier, it is possible to make the adjustment within a stable operation range without being affected by disturbances such as gravity, vibration, and the like.

Further, as described also in the first embodiment, by constituting the arithmetic circuits of the DPP signal and the LPS signal as shown in FIG. 4, the optimum DPP signal and LPS signal can be obtained by only one-time adjustment of K1 and K2 for every disk independently of a change of a laser power or a change of reflectance within the disk.

Further, in a case where readjustment of the spherical aberration correction is required for some reasons, when the initial values of K1 and K2 at that time are set to the optimum values which are the previous adjustment results and then the readjustment of the spherical aberration, K1, and K2 is performed, the tracking control at the time of the spherical aberration correction adjustment can be performed more stably.

Further, it is also preferable that first, the adjustment of K2 (from S7 to S11 of FIG. 6) is performed, and the obtained value of K2 is set to both K1 and K2 (S1 of FIG. 6), and then the adjustment of the spherical aberration is performed. In that case, the tracking control can be effected stably with less occurrence of offset due to the movement of the objective lens. Also in this case, the adjustment of K2 based on the flow of FIG. 6 is performed again.

### Third Embodiment

Next, a third embodiment of the present invention will be described. Although the constitution of the present embodiment is the same as that in FIG. 1, it is different from the first embodiment in that an optical disk 1 is an optical disk having an information surface of two layers. Other component parts are the same as those of the first embodiment.

The optical disk 1 has two information surfaces of a first information surface located apart by 75 μm from the disk surface, and a second information surface located apart by 100 μm from the disk surface with an intermediate layer of 25 μm in thickness therebetween. An optical head 2 is also constituted similarly to that in FIG. 2.

The spherical aberration generating means 111 has an aberration generating range which is sufficiently wide to be able to correspond to the two layer disk, and moves a lens 108 by micrometer order through a lead screw by means of a stepping motor.

The arithmetic operation method of the DPP signal and the LPS signal is the same as that of the first embodiment. The DPP signal is inputted to the switch 16 through the tracking control circuit 14, and the LPS signal is inputted to another terminal of the switch 16 through the lens position control circuit 15. The switch 16 is controlled by the controller 18, and is connected to the tracking control circuit 14 at the time of tracking control, and is connected to the lens position control circuit 15 at the time of lens position control. Further, the switch 16 is connected to a tracking actuator in the optical head 2 through the driver 17, thereby constituting respective control loops.

Further, the controller 18 controls the spherical aberration generating means 111 in the optical head 2 shown in FIG. 2 through the driver circuit 20, thereby adjusting the spherical aberration to be in an optimum state.

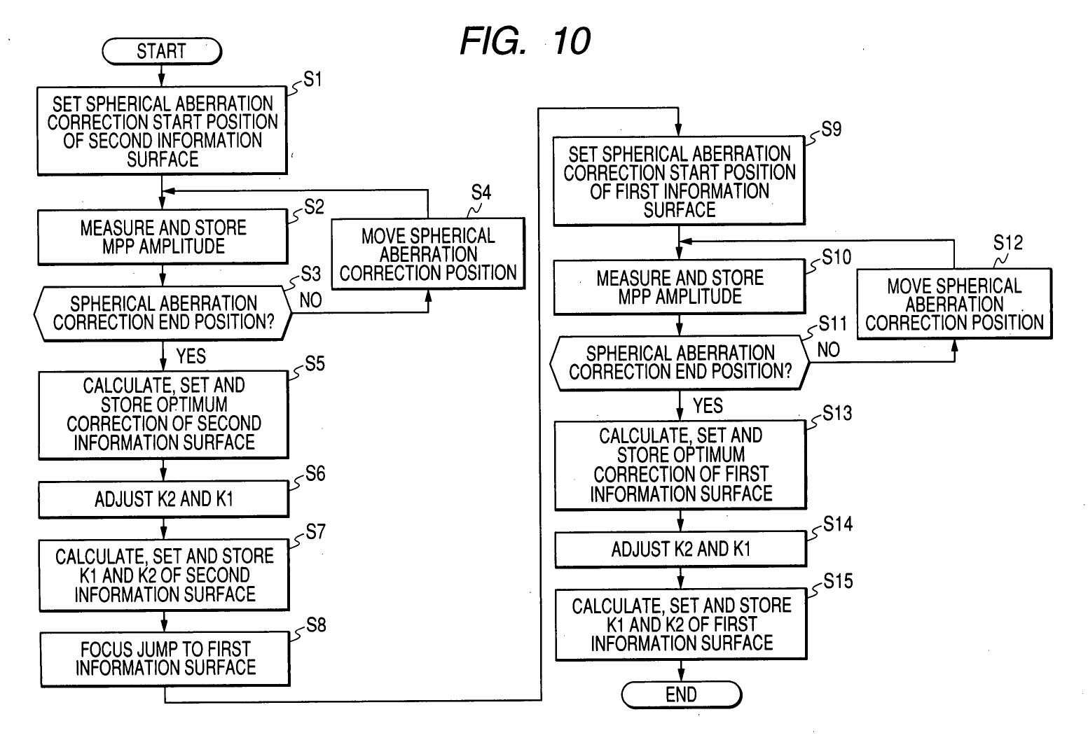

Next, the adjusting method of the spherical aberration, the DPP, and the LPS for every information surface will be described along the flowchart of FIG. 10. When the optical disk device is activated, the controller 18 performs activation of a spindle 19, turning on of a laser, focus pull-in, and the like. The first focus pull-in is performed on the second information surface more apart from the disk surface. The adjustment is performed under focus control of the second information surface of the optical disk 1. Although the focus control is not described in detail, a focus error signal is detected by a conventional astigmatic focus error detection technique from the four outputs A, B, C, and D of the photodetector, thereby performing the focus control.

The adjustment starts from the spherical aberration correction. When a spherical aberration correction routine starts, first, the spherical aberration generating means 111 (the movable lens 108) is set to a predetermined start position (S1). For example, in a case where the medium substrate thickness of the second information surface is an ordinary one, the start position is a position deviated by a predetermined amount from the reference position with designed values giving such an aberration as to eliminate the spherical aberration on the second information surface. The generation amount of the spherical aberration at this time is assumed to be −4.

It is further assumed, for example, that one unit of this generation amount moves the lens 108 by 10 μm. As with the first embodiment, since the focus position is changed by 1 μm for every 20 μm movement of the lens 108 as described above, the 10 μm movement corresponds to 0.5 μm change of the focus position. The amount “−4” refers to a state in which the lens 108 is moved by 40 μm from the reference position in a direction approaching to the lens 107. This state corresponds in design to a position where the spherical aberration becomes the optimum state when the thickness of the medium substrate up to the second information surface increases by 2 μm in a thicker direction.

Next, the controller 18 inputs the output signal amplitude of the MPP signal, which is the push-pull signal of the main beam, from an MPP signal amplitude measuring circuit 21, and stores it in a memory or the like as an evaluation index in association with the correction amount −4 (S2).

Next, the controller 18 confirms whether or not the spherical aberration generating means 111 (the movable 108) is at an end position (S3). The end position corresponds to a position of +4 in terms of the spherical aberration generation amount, and is in a state in which the lens 108 is moved by 40 μm from the reference position in the direction departing from the lens 107. This state corresponds in design to a position where the spherical aberration becomes the optimum state when the thickness of the medium substrate of the second information surface decreases by 2 μm in a thinner direction.

In a case where the spherical aberration generating means 111 is not at the end position, the spherical aberration correction amount is increased stepwise each by one until it comes to the end position (S4), and the MPP signal amplitude is measured by the MPP signal amplitude measuring circuit 21, and is stored in association with the correction amount (S2). Since the correction amount is increased one by one unit, this means that the lens 108 is moved stepwise each by 10 μm, and the MPP signal amplitude at that position is evaluated.

The constitution of the MPP signal amplitude measuring circuit 21 is the same as that of the first embodiment. Further, the method of determining an optimum spherical aberration correction amount on the basis of the correction amount and the MPP amplitude value is also the same as that of the first embodiment. Next, the thus determined correction amount is stored as the correction amount of the second information surface (S5). In this manner, the correction of the spherical aberration is completed.

Subsequently, the adjustments of K1, K2 of the DPP and LPS signals are performed. Since this adjusting method is the same as the adjusting method of the first embodiment, the description thereof will be omitted here (S6). After the values of K1 and K2 have been determined, these values are stored as the value for the second information surface (S7).

Next, with the tracking control being kept in off state, the spherical aberration generating means 111 (the movable lens 108) is set to a designed optimum value for the first information surface, and a focus jump to the first information surface is performed (S8). When the focus jump is completed, the spherical aberration generating means 111 (the movable lens 108) is set to a predetermined start position of the first information surface (S9).

For example, in a case where the medium substrate thickness of the first information surface is an ordinary one, the start position is a position deviated by a predetermined amount from the reference position with designed values giving such an aberration as to eliminate the spherical aberration on the first information surface. The reference position here is different from the reference position of the second information surface initially determined. Since the second information surface and the first information surface are 25 μm apart from each other, and since the first information surface is located closer to the disk surface, the reference position for the first information surface is apart by 500 μm form the reference position for the second information surface in the direction departing from the lens 107. The start position for the first information surface is a position which is apart by a predetermined amount from this position.

The generation amount of the-spherical aberration at this time is assumed to be −4. The amount “−4” refers to a state in which the lens 108 is moved by 40 μm from the reference position in a direction approaching to the lens 107. This state corresponds in design to a position where the spherical aberration becomes the optimum state when the thickness of the medium substrate up to the first information surface increases by 2 μm in a thicker direction.

Next, the controller 18 inputs the output signal amplitude of the MPP signal, which is the push-pull signal of the main beam, from an MPP signal amplitude measuring circuit 21, and stores it in a memory or the like as an evaluation index in association with the correction amount −4 (S10). Next, the controller 18 confirms whether or not the spherical aberration generating means 111 (the movable 108) is at an end position (S11).

The end position corresponds to a position of +4 in terms of the spherical aberration generation amount, and is in a state in which the lens 108 is moved by 40 μm from the reference position in the direction departing from the lens 107. This state corresponds in design to a position where the spherical aberration becomes the optimum state when the thickness of the medium substrate of the first information surface decreases by 2 μm in a thinner direction.

In a case where the spherical aberration generating means 111 is not at the end position, the spherical aberration correction amount is increased stepwise each by one until it comes to the end position (S12), and the MPP signal amplitude is measured by the MPP signal amplitude measuring circuit 21, and is stored in association with the correction amount (S10). Since the correction amount is increased one by one unit, this means that the lens 108 is moved stepwise each by 10 μm, and the MPP signal amplitude at that position is evaluated.

The constitution of the MPP signal amplitude measuring circuit 21 is the same as that of the first embodiment. Further, the method of determining an optimum spherical aberration correction amount on the basis of the correction amount and the MPP amplitude value is also the same as that of the first embodiment. Next, the thus determined correction amount is stored as the correction amount of the first information surface (S13). In this manner, the correction of the spherical aberration is completed.

Subsequently, the adjustments of K1, K2 of the DPP and LPS signals are performed. Since this adjusting method is the same as the adjusting method of the first embodiment, the description thereof will be omitted here (S14). After the values of K1 and K2 have been determined, these values are stored as the value for the first information surface (S15). In this manner, the adjustments of the spherical aberration correction amounts and the gains K1 and K2 of the DPP and the LPS of the respective information surfaces are completed. The recording/reproducing at each information surface is performed by using the adjustment value for each information surface.

In the present embodiment, since all the adjustments for the respective information surfaces are completed with the tracking control being in off state, there is no need to turn on tracking control by the DPP signal which has not been adjusted. Further, for every information surface, the adjustment of the spherical aberration is performed first and then the adjustments of the DPP and the LPS are performed, so that, after the adjustments are completed, the spherical aberration as well as the DPP and LPS signals have all become the optimum values, and the recording/reproducing operations can be started immediately.

Incidentally, though in this embodiment, the optical system as shown in FIG. 2 is used as the spherical aberration correcting means, any system may be adopted as long as it is a system in which a DPP signal is affected by occurrence of spherical aberration such as a liquid crystal element.

Further, although in this embodiment, the description has been made by taking the two layer optical disk as an example, the present invention is not limited to use of the two layers, but can be applied to any number of layers by performing adjustment for each layer thereof.

This application claims priority from Japanese Patent Application No. 2004-323681 filed Nov. 8, 2004, which is hereby incorporated by reference herein.

What is claimed is:

1. An optical information recording/reproducing apparatus, comprising:
a light source;
a wavefront splitting element for splitting a light flux from the light source into three light fluxes of 0-order light and ±1-order lights;
an objective lens for condensing the light fluxes as split by the wavefront splitting element on
an optical recording medium;
a spherical aberration generating means disposed between the light source and the objective lens, for generating a spherical aberration in the light fluxes;
a first adjusting means for adjusting a generation amount of the spherical aberration of the spherical aberration generating means;
a photodetector for detecting reflected lights from the optical recording medium of the three light fluxes;
an arithmetic operation means for arithmetically operating an tracking error signal or an objective lens position signal showing a position in a tracking direction of the objective lens, based on an output signal of the photodetector; and
a second adjusting means for adjusting a gain in the arithmetic operation means after adjusting the generation amount of the spherical aberration by the first adjusting means.

2. The optical information recording/reproducing apparatus according to claim 1, wherein the adjustment of the spherical aberration generation amount by the first adjusting means is performed with tracking control being in off state.

3. The optical information recording/reproducing apparatus according to claim 1, wherein the adjustment of the spherical aberration generation by the first adjusting means and the adjustment of the gain by the second adjusting means are performed with lens position control being in on state.

4. The optical information recording/reproducing apparatus according to claim 1, wherein the arithmetic operation means has a first arithmetic operation means which generates a first push-pull signal MPP from the reflected light of the 0-order light by the output from the detector, generates a second and a third push-pull signals from the reflected lights of the ±1-order lights and generates a push-pull signal SPP of a sum thereof, and generates a tracking error signal DPP by subtracting from the MPP a signal obtained by multiplying the SPP by a gain K1, and second arithmetic operation means which generates an objective lens position signal LPS showing the position in the tracking direction of the objective lens by adding the MPP and a signal obtained by multiplying the SPP by a gain K2 together, and wherein the second adjusting means adjusts the gains K1 and K2 when arithmetically operating the tracking error signal and the objective lens position signal by the first and the second arithmetic operation means, respectively.

5. The optical information recording/reproducing apparatus according to claim 1, wherein the optical recording medium has a plurality of recording/reproducing information surfaces, and the adjustment of the spherical aberration generating means and the subsequent adjustment of the arithmetic operation means are performed for every recording/reproducing information surface.
